(19) United States
(12) Patent Application Publication
(10) Pub. No.: US 2009/0026012 A1
(43) Pub. Date: Jan. 29, 2009

(54) Safety Harness Equipped with an Improved Belt

(75) Inventors: Paul Petzl, Barraux (FR); Jean-Marc Hede, Domene (FR)

Correspondence Address: OLIFF & BERRIDGE, PLC, P.O. BOX 320850, ALEXANDRIA, VA, 22320-4850, US

(73) Assignee: ZEDEL, CROLLES (FR)

(21) Appl. No.: 11/887,915

(22) PCT Filed: Oct. 6, 2006
(86) PCT No.: PCT/FR2006/002251

§ 371 Date: Oct. 5, 2007

(30) Foreign Application Priority Data
Oct. 14, 2005 (FR) 0510507

(51) Int. Cl. A62B 35/00; A62B 1/16

(52) U.S. Cl. 182/6; 182/3

(57) ABSTRACT

A roping harness is achieved from a lining structure 120 composed of an aerated double texture 13 comprising a first internal comfort layer superposed on a second external abrasion-resistance layer, and reinforcing means comprising an intermediate preform 17B of greater rigidity inserted and joined between the first and second layers by the biases 18.

Such a texture enables the strength and comfort of the harness to be improved.

### BACKGROUND OF THE INVENTION

The invention relates to a safety harness used in mountaineering and comprising a belt having a lining structure reinforced by biases sewn edgewise along the periphery, and attachment means joining the ends of the lining structure to the front of the belt.

### STATE OF THE ART

It is known to use a harness having a belt formed by a breathing fabric or a perforated cloth strip extending over the whole length around the user's waist. The fabric of the belt enables a good aeration limiting condensation in the tightened position, but its great flexibility tends to cause a shrinking effect affecting the user's comfort and distribution of the forces in case of a fall.

It is also known to use a harness belt formed by a padded fabric extending over the whole length, the edges of which are covered by reinforcing biases. The presence of the padded fabric gives the belt a good mechanical strength, but the belt is however heavier and has insufficient aeration enhancing perspiration.

The document US 2005/0121040 describes a harness comprising a homogeneous flexible structure formed by a superposition of several layers comprising a nylon netting bordered by biases, a padding lining, and a superficial fabric. These different layers can adhere to one another by stitching or by sticking and the belt is made in a single part with the rest of the structure of the harness. Manufacture of such a harness is complicated.

### OBJECT OF THE INVENTION

The object of the invention consists in providing a harness belt procuring both optimum comfort and a high mechanical strength, while at the same time reducing the weight of the whole assembly with quick manufacturing.

The harness according to the invention is characterized in that the lining structure is composed:
of an aerated double texture comprising a first internal comfort layer superposed on a second external abrasion-resistant layer,
and of reinforcing means comprising an intermediate preform of greater rigidity inserted and joined between the first and second layers by the biases.

Such a texture reinforced by the preform prevents the netting from shrinking when used and gives the belt a good comfort of use, an efficient aeration and mechanical strength, and a well-balanced distribution of forces. The two layers of the flexible texture can be of the same nature or of different natures and are constituted by a fine-mesh netting.

According to a first version of the attachment device, the preform presents a perforated surrounding outline able to be reinforced by a stiffener.

According to a second version of the attachment device, the preform comprises an intercalated foam lining perforated with holes.

In both cases, the external outline of the preforms constitutes the edge of the reinforcing biases.

### BRIEF DESCRIPTION OF THE DRAWINGS

Other advantages and features will become more clearly apparent from the following description of an embodiment of the invention given as a non-restrictive example only and represented in the accompanying drawings, in which:

FIG. 1 is a schematic perspective view of a roping harness equipped with a belt according to the invention;

FIG. 2 shows a developed large-scale view of the belt used in FIG. 1;

FIG. 3 represents a cross-sectional view along the line 3-3 of FIG. 2;

FIG. 4 is a view of the reinforcing preform in the form of a surround used in the belt of FIG. 2;

FIG. 5 represents a cross-sectional view along the line 5-5 of FIG. 2;

FIG. 6 represents an identical view to FIG. 2 of an alternative embodiment;

FIG. 7 is a cross-sectional view along the line 7-7 of FIG. 6;

FIG. 8 is a view of the perforated foam preform used in the belt of FIG. 6;

FIG. 9 represents a cross-sectional view along the line 9-9 of FIG. 6.

### DETAILED DESCRIPTION OF THE INVENTION

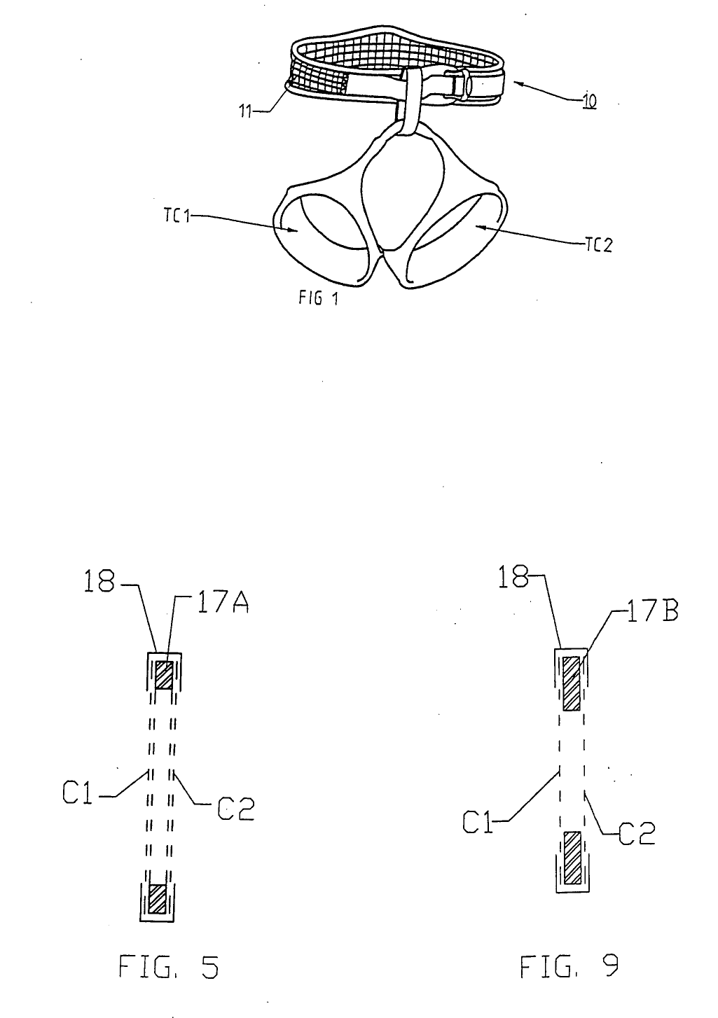

With reference to FIG. 1, a roping harness 10, in particular for mountaineering, is equipped with a belt 11 joined to a sit harness equipped with a pair of leg loops TC1, TC2. The structure of the sit harness is for example of the described in the document FR-A-2796296.

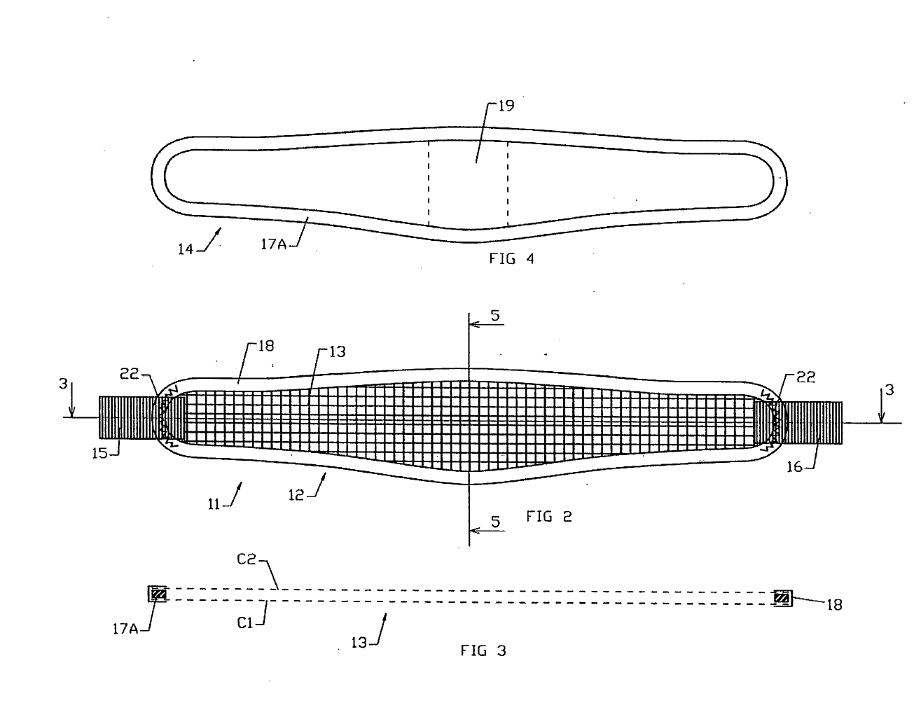

In FIGS. 2 to 5, the belt 11 comprises a lining structure 12 composed of an aerated double texture 13, and reinforcing means 14 joined to attachment webbing straps 15, 16. The double texture 13 comprises a first internal comfort layer C1 superposed on a second external abrasion-resistant layer C2. Each layer C1, C2 is preferably achieved by a netting that is not very elastic and very flexible, which can be formed by an aerated fine-mesh synthetic cloth or a breathing fabric enabling an aeration effect preventing perspiration under the belt 11.

The reinforcing means 14 are arranged as an intermediate preform 17A of greater rigidity inserted and joined between the first and second layers C1, C2 by the biases 18. The preform 17A presents a perforated surrounding outline (FIG. 4) able to be reinforced in the middle part by a stiffener 19. The mechanical strength of the belt 11 is reinforced by the presence of the biases 18 sewn onto the whole periphery of the lining structure 12. The presence of the preform 17A reinforced by the biases 18 prevents the double texture 13 from shrinking in use, in particular in the case of the climber falling. This results in a good comfort of use and an efficient mechanical strength due to an optimum dorsal distribution of the forces.

The external layer C2 constitutes the resistance netting, whereas the internal layer C1 constitutes the comfort netting in contact with the user. The two layers C1, C2 of the double texture 13 can advantageously be of different natures, in particular polyamide- or polyester-based, or made from any other high-strength textile fibre.

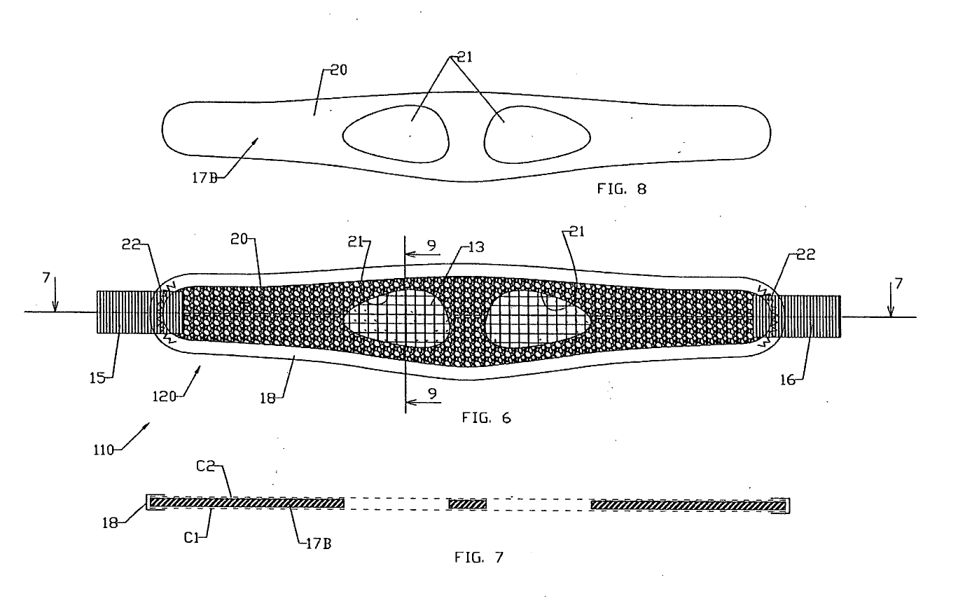

With reference to the belt 110 illustrated in FIGS. 6 to 9, the preform 17B comprises an intercalated foam lining 20, which is inserted in the thickness direction between the two layers C1, C2 of the double texture 13 to reinforce the dorsal strength of the belt 110. The intercalated foam lining 20 is perforated with holes 21, two in the example of FIG. 8, which have larger dimensions than those of the meshes of the netting of the two layers C1 and C2.

The external outline of the preform 17B is similar to that of the preform 17A and constitutes the edge of the biases 18 along the lining structure 120.

The attachment device with fixing webbing straps 15, 16 is identical to that of the belt 11 of FIG. 2, being securedly attached by stitching 22 to the opposite ends of the lining structure 12, 120.

It is clear that the aerated texture with biases according to the invention described above can be used to achieve a sit harness or chest harness.

1. Roping harness equipped with a belt comprising a lining structure reinforced by biases sewn edgewise along the periphery, and attachment means joining the ends of the lining structure at the front of the belt, the lining structure being composed:
of an aerated double texture comprising a first internal comfort layer superposed on a second external abrasion-resistant layer,
and of reinforcing means of greater rigidity inserted and joined between the first and second layers by the biases,
wherein the reinforcing means comprise an intermediate preform having a perforated surrounding outline with an external edge supporting the biases.

2. Roping harness according to claim 1, wherein the preform can be reinforced by at least one stiffener.

3. Roping harness according to claim 1, wherein the preform comprises an intercalated foam lining perforated with holes.

4. Roping harness according to claim 1, wherein the first layer and/or the second layer of the flexible texture comprise(s) a fine-meshed netting.

5. Roping harness according to claim 1, wherein the attachment means comprise fixing webbing straps sewn onto the texture and onto the preform by biases.

6. Roping harness according to claim 1, wherein the flexible texture is made from a high-strength textile fibre, in particular polyamide- or polyester-based.

7. (canceled)
